(19) United States
(12) Patent Application Publication
(10) Pub. No.: US 2025/0376217 A1
(43) Pub. Date: Dec. 11, 2025

(54) REAR SIDE STRUCTURE FOR VEHICLE

(71) Applicants: Hyundai Motor Company, Seoul (KR); Kia Corporation, Seoul (KR)

(72) Inventors: Keon Woo Kim, Hwaseong-si (KR); Song Jae Jeong, Hwaseong-si (KR)

(21) Appl. No.: 18/938,856

(22) Filed: Nov. 6, 2024

(30) Foreign Application Priority Data
Jun. 10, 2024 (KR) 10-2024-0075239

(51) Int. Cl. B62D 25/02; B62D 25/20

(52) U.S. Cl. CPC B62D 25/025; B62D 25/2009

(57) ABSTRACT

An embodiment rear side structure for a vehicle includes a side sill extending in a longitudinal direction of the vehicle, a rear wheel house located behind the side sill, a first reinforcing member fixed to a front portion of the rear wheel house, a second reinforcing member fixed to a rear portion of the side sill, and a third reinforcing member connecting the first reinforcing member and the second reinforcing member and fixed to the rear wheel house.

### CROSS-REFERENCE TO RELATED APPLICATIONS

This application claims the benefit of Korean Patent Application No. 10-2024-0075239, filed on Jun. 10, 2024, which application is hereby incorporated herein by reference in its entirety.

### TECHNICAL FIELD

The present disclosure relates to a rear side structure for a vehicle.

### BACKGROUND

In recent years, as the perception of environmental crisis and depletion of oil resources has increased, eco-friendly electric vehicles such as electric vehicles (EVs) and hybrid electric vehicles (HEVs) have risen to prominence. Each of EVs and HEVs has one or more batteries mounted on the bottom of a vehicle body, and accordingly the weight thereof increases due to such relatively heavy batteries, compared to the weight of internal combustion engine vehicles (vehicles only equipped with an internal combustion engine).

Due to the batteries mounted on the bottom of the vehicle body of the EV, torsional stiffness of the vehicle body may be reduced, so the EV needs to improve the torsional stiffness of the vehicle body. In order to cope with a side collision or a front collision of the vehicle, stiffness of the periphery of a rear wheel house needs to be increased. During replacement of a rear wheel of the vehicle, a jack-up mechanism may be located at a front portion of the rear wheel house of the vehicle body, and it may lift the front portion of the rear wheel house of the vehicle body. Here, as a vertical load is transferred to the front portion of the rear wheel house of the vehicle body, stiffness of the front portion of the rear wheel house needs to be increased.

During the collision of the vehicle, loads may be transferred to the rear wheel house in various directions, so the periphery of the rear wheel house may be severely deformed.

A rear side structure for a vehicle may affect longitudinal stiffness, torsional stiffness, and the like of the vehicle in terms of crashworthiness and may affect vertical stiffness of the vehicle in terms of durability. The rear side structure may correspond to a connection portion of various load paths. The rear side structure may include a plurality of reinforcing members mounted between a rear portion of a side sill and the rear wheel house. The stiffness of the periphery of the rear wheel house may be improved by the plurality of reinforcing members.

When a rear side structure for a vehicle according to the related art satisfies one performance, it may not satisfy the other performance. For example, when the reinforcing members only connect the side sill and the rear wheel house in a height direction (vertical direction) of the vehicle, the periphery of the rear wheel house may be severely deformed during a collision. In addition, when the reinforcing members only connect the side sill and the rear wheel house in a longitudinal direction of the vehicle, torsional stiffness and durability may be reduced.

In the related art rear side structure, the plurality of reinforcing members may not be connected in the longitudinal direction of the vehicle due to interference occurring during assembly, but the plurality of reinforcing members may only be connected in the height direction of the vehicle so that the plurality of reinforcing members may only connect the rear portion of the side sill and the rear wheel house in the height direction of the vehicle. As the loads transferred to the rear wheel house in various directions are only transferred in the height direction of the vehicle through the plurality of reinforcing members, the loads may not be distributed in various directions, and thus the periphery of the rear wheel house may be severely deformed.

The above information described in this background section is provided to assist in understanding the background of the inventive concept, and it may include any technical concept which is not considered as the already known prior art.

### SUMMARY

The present disclosure relates to a rear side structure for a vehicle. Particular embodiments relate to a rear side structure for a vehicle designed to connect a side sill and a rear wheel house in various directions.

Embodiments of the present disclosure can solve problems occurring in the prior art while advantages achieved by the prior art are maintained intact.

An embodiment of the present disclosure provides a rear side structure for a vehicle designed to connect a side sill and a rear wheel house in various directions, thereby allowing loads transferred to the rear wheel house to be uniformly distributed in various directions.

According to an embodiment of the present disclosure, a rear side structure for a vehicle may include a side sill extending in a longitudinal direction of the vehicle, a rear wheel house located behind the side sill, a first reinforcing member fixed to a front portion of the rear wheel house, a second reinforcing member fixed to a rear portion of the side sill, and a third reinforcing member connecting the first reinforcing member and the second reinforcing member and fixed to the rear wheel house.

The first reinforcing member may include a top wall extending obliquely along the front portion of the rear wheel house and a side flange extending along an inner edge of the top wall.

The first reinforcing member may further include a bottom flange extending from a bottom end of the side flange toward the second reinforcing member and a connecting projection protruding from a bottom end of the top wall toward the second reinforcing member.

The second reinforcing member may include a top wall and a top flange connected to an inner edge of the top wall. The bottom flange of the first reinforcing member may be fixed to the top flange of the second reinforcing member, and the connecting projection of the first reinforcing member may be fixed to the top wall of the second reinforcing member.

The connecting projection of the first reinforcing member may be fixed to a rear portion of the second reinforcing member and a front portion of the third reinforcing member.

The front portion of the third reinforcing member may be overlapped with and fixed to the rear portion of the second reinforcing member, and a rear portion of the third reinforcing member may be fixed to the rear wheel house.

The third reinforcing member may include a top wall extending from the second reinforcing member toward the rear wheel house in the longitudinal direction of the vehicle.

The third reinforcing member may further include an upper extension portion extending upward from a rear portion of the top wall, and the upper extension portion of the third reinforcing member may be fixed to the rear wheel house.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a side view of a side structure of a vehicle including a rear side structure according to an exemplary embodiment of the present disclosure;

FIG. 2 illustrates a side view of a rear side structure according to an exemplary embodiment of the present disclosure;

FIG. 3 illustrates a perspective view of a rear side structure according to an exemplary embodiment of the present disclosure;

FIG. 4 illustrates an exploded perspective view of a rear side structure according to an exemplary embodiment of the present disclosure;

FIG. 5 illustrates a perspective view of a side sill of a rear side structure according to an exemplary embodiment of the present disclosure;

FIG. 6 illustrates a perspective view of a first reinforcing member of a rear side structure according to an exemplary embodiment of the present disclosure;

FIG. 7 illustrates a perspective view of a second reinforcing member of a rear side structure according to an exemplary embodiment of the present disclosure;

FIG. 8 illustrates a perspective view of a third reinforcing member of a rear side structure according to an exemplary embodiment of the present disclosure;

FIG. 9 illustrates a cross-sectional view taken along line A-A of FIG. 2; and

FIG. 10 illustrates a cross-sectional view taken along line B-B of FIG. 9.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with embodiments of the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and they are not to be interpreted as having ideal or excessively formal meanings unless clearly defined as having such in the present application.

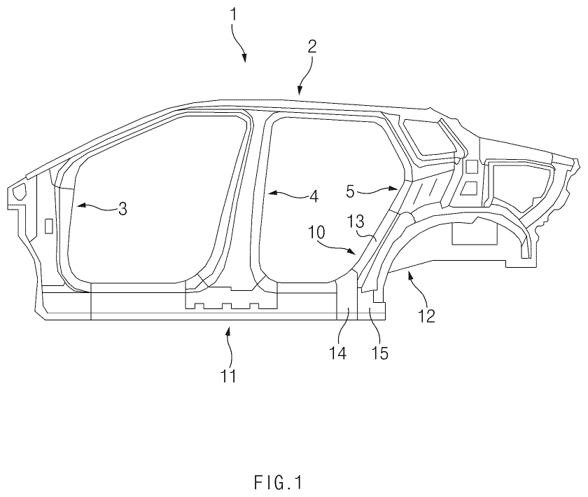

Referring to FIG. 1, a side structure 1 of a vehicle may include a roof side rail 2 extending in a longitudinal direction of the vehicle on the top of the vehicle and a side sill 11 extending in the longitudinal direction of the vehicle on the bottom of the vehicle. A front pillar 3 may be located on the front of the vehicle, and the front pillar 3 may connect a front portion of the roof side rail 2 and a front portion of the side sill 11. A center pillar 4 may be located behind the front pillar 3, and the center pillar 4 may connect a middle portion of the roof side rail 2 and a middle portion of the side sill 11. A rear pillar 5 may be located behind the center pillar 4, and the rear pillar 5 may connect a rear portion of the roof side rail 2 and a rear portion of the side sill 11. The front pillar 3, the roof side rail 2, the center pillar 4, and the side sill 11 may define a front door opening. The center pillar 4, the roof side rail 2, the rear pillar 5, and the side sill 11 may define a rear door opening. A rear wheel house 12 may be connected to a lower portion of the rear pillar 5, and the rear wheel house 12 may be located behind the side sill 11.

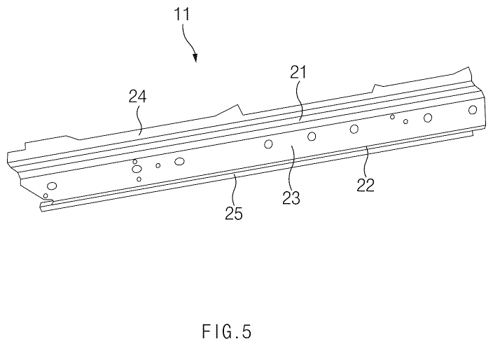

The side sill 11 may be an outer side sill facing the exterior of the vehicle. The front portion of the side sill 11 may be fixed to a bottom end of the front pillar 3 using fasteners, welding, and/or the like, and the rear portion of the side sill 11 may be connected to the rear wheel house 12 through a plurality of reinforcing members 13, 14, and 15. Referring to FIG. 5, the side sill 11 may include a top wall 21 facing the top of the vehicle, a bottom wall 22 facing the bottom of the vehicle, an outboard sidewall 23 facing the exterior of the vehicle, a top flange 24 connected to the top wall 21, and a bottom flange 25 connected to the bottom wall 22.

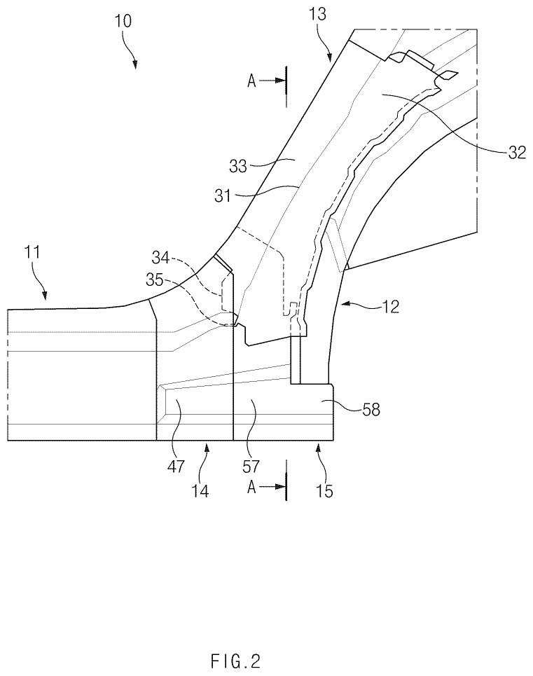

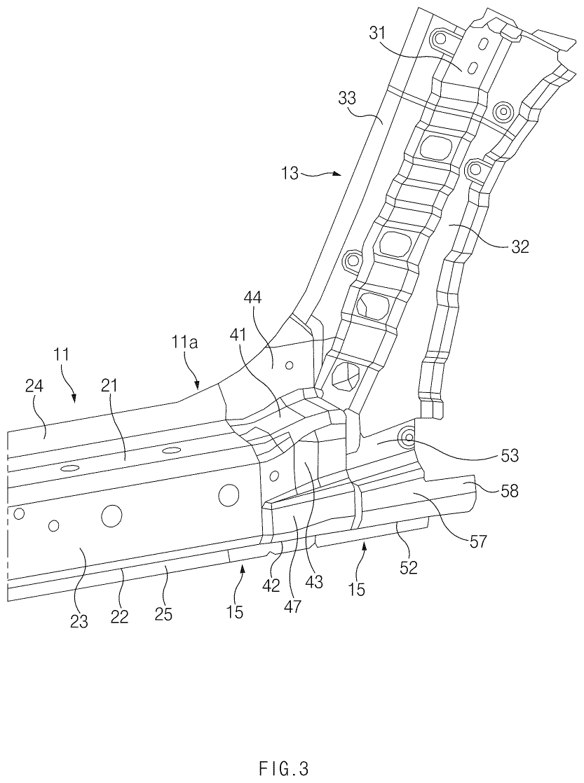

Referring to FIGS. 2 to 4, a rear side structure 10 for a vehicle may include the plurality of reinforcing members 13, 14, and 15 connecting the rear portion of the side sill 11 and the rear wheel house 12 in the longitudinal direction and height direction of the vehicle.

The plurality of reinforcing members 13, 14, and 15 may include a first reinforcing member 13 fixed to a front portion of the rear wheel house 12 and the lower portion of the rear pillar 5, a second reinforcing member 14 fixed to the rear portion of the side sill 11, and a third reinforcing member 15 connecting the first reinforcing member 13 and the second reinforcing member 14.

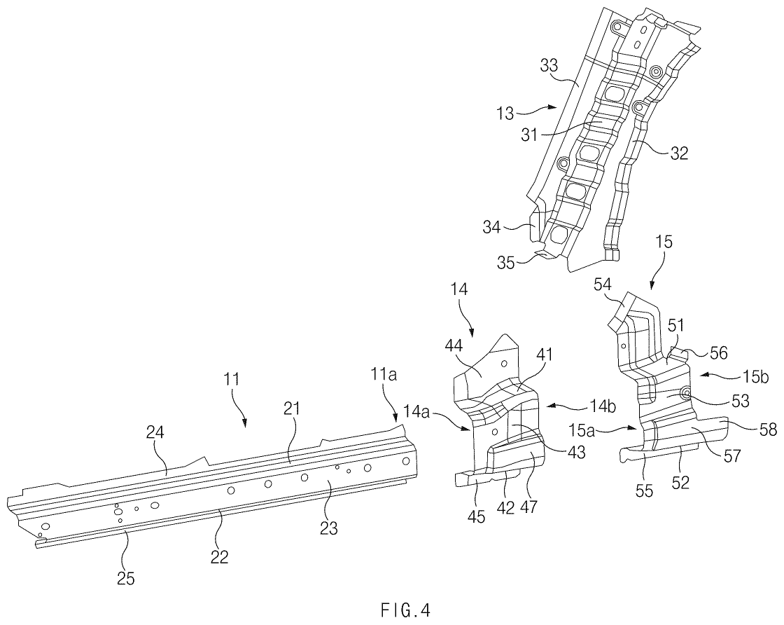

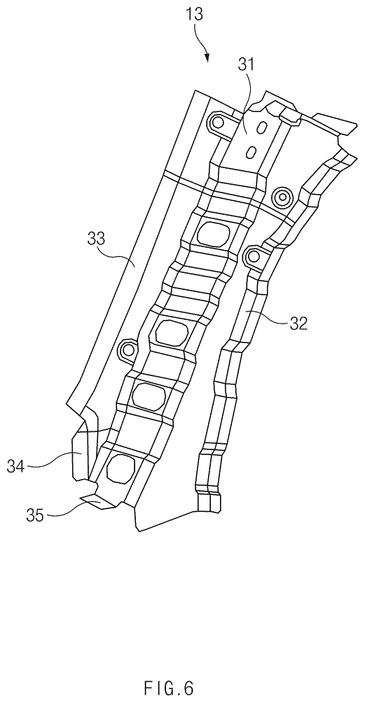

The first reinforcing member 13 may extend in the height direction of the vehicle on the front portion of the rear wheel house 12. Referring to FIGS. 4 and 6, the first reinforcing member 13 may include a top wall 31 facing the top of the vehicle, an outboard sidewall 32 connected to an outer edge of the top wall 31, and a side flange 33 connected to an inner edge of the top wall 31. The top wall 31 may extend obliquely along the front portion of the rear wheel house 12, the outboard sidewall 32 may extend along the outer edge of the top wall 31, and the side flange 33 may extend along the inner edge of the top wall 31.

A striker or other various components may be fixed to the top wall 31 of the first reinforcing member 13 using fasteners, welding, and/or the like. A door latch of a rear door may be locked or unlocked with respect to the striker. The outboard sidewall 32 of the first reinforcing member 13 may be fixed to the front portion of the rear wheel house 12 using fasteners, welding, and/or the like, and the side flange 33 of the first reinforcing member 13 may be fixed to the lower portion of the rear pillar 5 using fasteners, welding, and/or the like. Accordingly, stiffness of the front portion of the rear wheel house 12 may be improved by the first reinforcing member 13.

The first reinforcing member 13 may further include a bottom flange 34 and a connecting projection 35 provided on a bottom end thereof. Referring to FIGS. 4 and 6, the bottom flange 34 may extend from the side flange 33 toward the second reinforcing member 14, and the connecting projection 35 may protrude from a bottom end of the top wall 31 toward the second reinforcing member 14. The bottom flange 34 and the connecting projection 35 of the first reinforcing member 13 may be fixed to the second reinforcing member 14 using fasteners, welding, and/or the like, and accordingly the first reinforcing member 13 and the second reinforcing member 14 may be connected in the height direction of the vehicle.

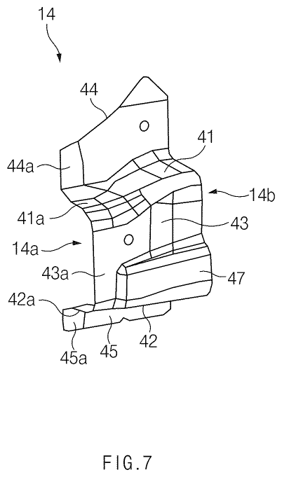

The second reinforcing member 14 may extend from the rear portion 11a of the side sill 11 toward the rear wheel house 12 in the longitudinal direction of the vehicle. Referring to FIGS. 4 and 7, the second reinforcing member 14 may include a top wall 41 facing the top of the vehicle, a bottom wall 42 facing the bottom of the vehicle, an outboard sidewall 43 connecting an outer edge of the top wall 41 and an outer edge of the bottom wall 42, a top flange 44 connected to an inner edge of the top wall 41, and a bottom flange 45 connected to an inner edge of the bottom wall 42. The top wall 41 of the second reinforcing member 14 may extend from the side sill 11 toward the rear wheel house 12 in the longitudinal direction of the vehicle.

The second reinforcing member 14 may further include a reinforcing bead 47 raised from the outboard sidewall 43 toward the exterior of the vehicle, and stiffness of the second reinforcing member 14 may be improved by the reinforcing bead 47.

The bottom flange 34 of the first reinforcing member 13 may be fixed to the top flange 44 of the second reinforcing member 14 using fasteners, welding, and/or the like so that the side flange 33 of the first reinforcing member 13 may be connected to the top flange 44 of the second reinforcing member 14. The connecting projection 35 of the first reinforcing member 13 may be fixed to the top wall 41 of the second reinforcing member 14 using fasteners, welding, and/or the like so that the top wall 31 of the first reinforcing member 13 may be connected to the top wall 41 of the second reinforcing member 14.

A front portion 14a of the second reinforcing member 14 may be overlapped with the rear portion 11a of the side sill 11, and the front portion 14a of the second reinforcing member 14 may be fixed to the rear portion 11a of the side sill 11 using fasteners, welding, and/or the like. Referring to FIG. 7, the front portion 14a of the second reinforcing member 14 may include a first extension 41a extending from the top wall 41 toward the side sill 11, a second extension 42a extending from the bottom wall 42 toward the side sill 11, a third extension 43a extending from the outboard sidewall 43 toward the side sill 11, a fourth extension 44a extending from the top flange 44 toward the side sill 11, and a fifth extension 45a extending from the bottom flange 45 toward the side sill 11.

The first extension 41a of the second reinforcing member 14 may be recessed from the top wall 41, the first extension 41a of the second reinforcing member 14 may be fixed to the rear portion of the top wall 21 of the side sill 11 using fasteners, welding, and/or the like, and the top wall 41 of the second reinforcing member 14 may be aligned with the top wall 21 of the side sill 11.

The second extension 42a of the second reinforcing member 14 may be recessed from the bottom wall 42, the second extension 42a of the second reinforcing member 14 may be fixed to the rear portion of the bottom wall 22 of the side sill 11 using fasteners, welding, and/or the like, and the bottom wall 42 of the second reinforcing member 14 may be aligned with the bottom wall 22 of the side sill 11.

The third extension 43a of the second reinforcing member 14 may be recessed from the outboard sidewall 43, the third extension 43a of the second reinforcing member 14 may be fixed to the rear portion of the outboard sidewall 23 of the side sill 11 using fasteners, welding, and/or the like, and the outboard sidewall 43 of the second reinforcing member 14 may be aligned with the outboard sidewall 23 of the side sill 11.

The fourth extension 44a of the second reinforcing member 14 may be recessed from the top flange 44, the fourth extension 44a of the second reinforcing member 14 may be fixed to the rear portion of the top flange 24 of the side sill 11 using fasteners, welding, and/or the like, and the top flange 44 of the second reinforcing member 14 may be aligned with the top flange 24 of the side sill 11.

The fifth extension 45a of the second reinforcing member 14 may be recessed from the bottom flange 45, the fifth extension 45a of the second reinforcing member 14 may be fixed to the rear portion of the bottom flange 25 of the side sill 11 using fasteners, welding, and/or the like, and the bottom flange 45 of the second reinforcing member 14 may be aligned with the bottom flange 25 of the side sill 11.

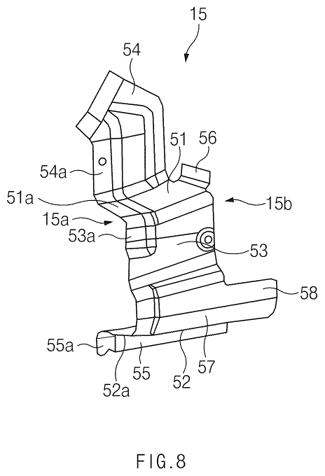

The third reinforcing member 15 may extend from the second reinforcing member 14 toward the rear wheel house 12 in the longitudinal direction of the vehicle. Referring to FIGS. 4 and 8, the third reinforcing member 15 may include a top wall 51 facing the top of the vehicle, a bottom wall 52 facing the bottom of the vehicle, an outboard sidewall 53 connecting an outer edge of the top wall 51 and an outer edge of the bottom wall 52, a top flange 54 connected to an inner edge of the top wall 51, and a bottom flange 55 connected to an inner edge of the bottom wall 52. The top wall 51 of the third reinforcing member 15 may extend from the second reinforcing member 14 toward the rear wheel house 12 along the longitudinal direction of the vehicle. A portion of the side flange 33 of the first reinforcing member 13 may be fixed to the top flange 54 of the third reinforcing member 15, and the top flange 54 and the bottom flange 55 of the third reinforcing member 15 may be fixed to the rear pillar 5 using fasteners, welding, and/or the like.

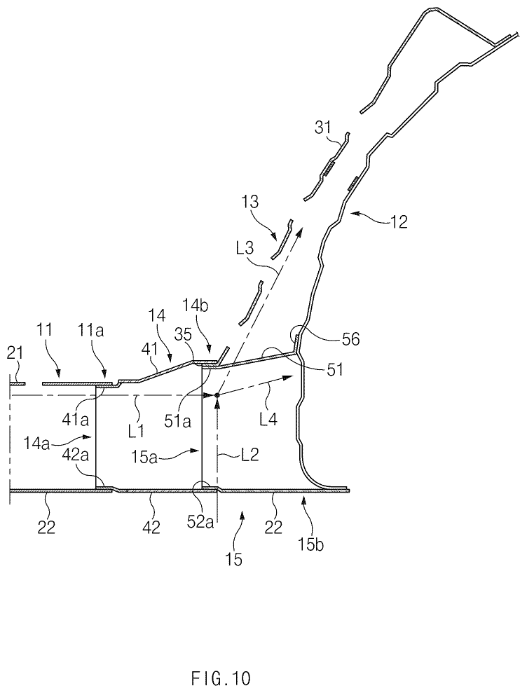

Referring to FIGS. 4 and 8, the third reinforcing member 15 may further include an upper extension portion 56 extending upward from a rear portion of the top wall 51. The upper extension portion 56 may extend upward at an inclined angle corresponding to that of a portion of the rear wheel house 12. Referring to FIG. 10, the upper extension portion 56 of the third reinforcing member 15 may be fixed to the rear wheel house 12 using fasteners, welding, and/or the like so that the top wall 51 of the third reinforcing member 15 may be connected to the rear wheel house 12.

Referring to FIGS. 4 and 8, the third reinforcing member 15 may further include a reinforcing bead 57 raised from the outboard sidewall 53 toward the exterior of the vehicle, and stiffness of the third reinforcing member 15 may be improved by the reinforcing bead 57. The reinforcing bead 57 of the third reinforcing member 15 may be aligned with the reinforcing bead 47 of the second reinforcing member 14 along the longitudinal direction of the vehicle, and accordingly stiffness of the rear side structure 10 may be improved by the reinforcing bead 47 of the second reinforcing member 14 and the reinforcing bead 57 of the third reinforcing member 15.

Referring to FIGS. 4 and 8, the third reinforcing member 15 may further include a lower extension portion 58 extending from the reinforcing bead 57 toward the rear wheel house 12, and the lower extension portion 58 may be fixed to the rear wheel house 12 using fasteners, welding, and/or the like. Referring to FIG. 2, the third reinforcing member 15 may be firmly fixed to the rear wheel house 12 through the lower extension portion 58.

A front portion 15a of the third reinforcing member 15 may be overlapped with a rear portion 14b of the second reinforcing member 14, and the front portion 15a of the third reinforcing member 15 may be fixed to the rear portion 14b of the second reinforcing member 14 using fasteners, welding, and/or the like. Referring to FIG. 8, the front portion 15a of the third reinforcing member 15 may include a first extension 51a extending from the top wall 51 toward the second reinforcing member 14, a second extension 52a extending from the bottom wall 52 toward the second reinforcing member 14, a third extension 53a extending from the outboard sidewall 53 toward the second reinforcing member 14, a fourth extension 54a extending from the top flange 54 toward the second reinforcing member 14, and a fifth extension 55a extending from the bottom flange 55 toward the second reinforcing member 14.

The first extension 51a of the third reinforcing member 15 may be recessed from the top wall 51, the first extension 51a of the third reinforcing member 15 may be fixed to the rear portion of the top wall 41 of the second reinforcing member 14 using fasteners, welding, and/or the like, and the top wall 51 of the third reinforcing member 15 may be aligned with the top wall 41 of the second reinforcing member 14.

The second extension 52a of the third reinforcing member 15 may be recessed from the bottom wall 52, the second extension 52a of the third reinforcing member 15 may be fixed to the rear portion of the bottom wall 42 of the second reinforcing member 14 using fasteners, welding, and/or the like, and the bottom wall 52 of the third reinforcing member 15 may be aligned with the bottom wall 42 of the second reinforcing member 14.

The third extension 53a of the third reinforcing member 15 may be recessed from the outboard sidewall 53, the third extension 53a of the third reinforcing member 15 may be fixed to the rear portion of the outboard sidewall 43 of the second reinforcing member 14 using fasteners, welding, and/or the like, and the outboard sidewall 53 of the third reinforcing member 15 may be aligned with the outboard sidewall 43 of the second reinforcing member 14.

The fourth extension 54a of the third reinforcing member 15 may be recessed from the top flange 54, the fourth extension 54a of the third reinforcing member 15 may be fixed to the rear portion of the top flange 44 of the second reinforcing member 14 using fasteners, welding, and/or the like, and the top flange 54 of the third reinforcing member 15 may be aligned with the top flange 44 of the second reinforcing member 14.

The fifth extension 55a of the third reinforcing member 15 may be recessed from the bottom flange 55, the fifth extension 55a of the third reinforcing member 15 may be fixed to the rear portion of the bottom flange 45 of the second reinforcing member 14 using fasteners, welding, and/or the like, and the bottom flange 55 of the third reinforcing member 15 may be aligned with the bottom flange 45 of the second reinforcing member 14.

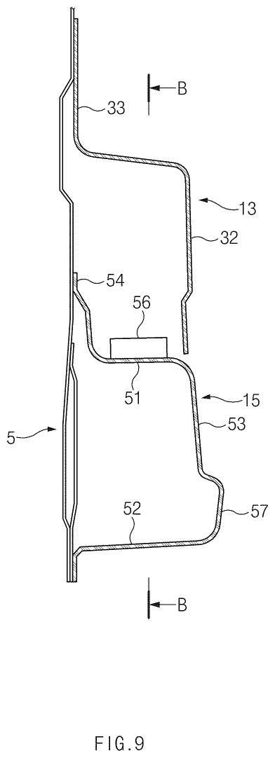

Referring to FIG. 9, the side flange 33 of the first reinforcing member 13 and the top flange 54 and the bottom flange 55 of the third reinforcing member 15 may be fixed to the lower portion of the rear pillar 5 using fasteners, welding, and/or the like. Each of the first reinforcing member 13 and the third reinforcing member 15 may be firmly connected and fixed to the lower portion of the rear pillar 5 so that the location of the top wall 51 of the third reinforcing member 15 may be varied.

Referring to FIG. 10, the first reinforcing member 13 may be fixed to the front portion of the rear wheel house 12, the second reinforcing member 14 may be fixed to the rear portion of the side sill 11, the third reinforcing member 15 may be fixed to the rear wheel house 12, and the third reinforcing member 15 may connect the first reinforcing member 13 and the second reinforcing member 14 so that the second reinforcing member 14 and the third reinforcing member 15 may connect the rear portion 11a of the side sill 11 and the rear wheel house 12 in the longitudinal direction of the vehicle, and the first reinforcing member 13 and the second reinforcing member 14 may connect the rear portion 11a of the side sill 11 and the rear wheel house 12 in the height direction (inclined direction) of the vehicle.

The connecting projection 35 of the first reinforcing member 13 may be fixed to the rear portion of the second reinforcing member 14 and the front portion of the third reinforcing member 15, and accordingly the first reinforcing member 13, the second reinforcing member 14, and the third reinforcing member 15 may be connected to each other. Referring to FIG. 10, the connecting projection 35 of the first reinforcing member 13 may be sandwiched between the top wall 41 of the second reinforcing member 14 and the first extension 51a of the third reinforcing member 15, and the connecting projection 35 of the first reinforcing member 13 may be fixed to the top wall 41 of the second reinforcing member 14 and the first extension 51a of the third reinforcing member 15 using fasteners, welding, and/or the like.

Referring to FIG. 10, the top wall 21 of the side sill 11 and the top wall 41 of the second reinforcing member 14 may define a first load path L1 in the longitudinal direction of the vehicle, and the third reinforcing member 15 may define a second load path L2 in the height direction of the vehicle. The top wall 31 of the first reinforcing member 13 may define a third load path L3 in the height direction (inclined direction) of the vehicle, and the top wall 51 of the third reinforcing member 15 may define a fourth load path L4 in the longitudinal direction of the vehicle. In the event of a collision of the vehicle, loads transferred to the third reinforcing member 15 through the first load path L1 and the second load path L2 may be distributed through the third load path L3 and the fourth load path L4 so that stiffness of the periphery of the rear wheel house 12 and torsional stiffness of the vehicle may be improved.

As described above, the first reinforcing member 13 and the second reinforcing member 14 may connect the side sill 11 and the rear wheel house 12 in the height direction (inclined direction) of the vehicle, and the second reinforcing member 14 and the third reinforcing member 15 may connect the side sill 11 and the rear wheel house 12 in the longitudinal direction of the vehicle so that the loads may be distributed between the side sill 11 and the rear wheel house 12 in various directions.

As set forth above, the rear side structure for a vehicle according to exemplary embodiments of the present disclosure may be designed to have the plurality of reinforcing members connecting the side sill and the rear wheel house in various directions so that the loads transferred to the rear wheel house may be distributed in various directions, and thus crashworthiness (longitudinal stiffness, torsional stiffness, and the like of the vehicle) and durability (vertical stiffness of the vehicle) may be improved.

Hereinabove, although embodiments of the present disclosure have been described with reference to exemplary embodiments and the accompanying drawings, the embodiments of the present disclosure are not limited thereto, but they may be variously modified and altered by those skilled in the art to which the present disclosure pertains without departing from the spirit and scope of the present disclosure claimed in the following claims.

What is claimed is:

1. A rear side structure for a vehicle, the rear side structure comprising:
a side sill extending in a longitudinal direction of the vehicle;
a rear wheel house located behind the side sill;
a first reinforcing member fixed to a front portion of the rear wheel house;
a second reinforcing member fixed to a rear portion of the side sill; and
a third reinforcing member connecting the first reinforcing member and the second reinforcing member and fixed to the rear wheel house.

2. The rear side structure according to claim 1, wherein the first reinforcing member comprises:
a first top wall extending obliquely along the front portion of the rear wheel house; and
a side flange extending along an inner edge of the first top wall.

3. The rear side structure according to claim 2, wherein the first reinforcing member further comprises:
a bottom flange extending from a bottom end of the side flange toward the second reinforcing member; and
a connecting projection protruding from a bottom end of the first top wall toward the second reinforcing member.

4. The rear side structure according to claim 3, wherein the second reinforcing member comprises:
a second top wall; and
a top flange connected to an inner edge of the second top wall.

5. The rear side structure according to claim 4, wherein:
the bottom flange of the first reinforcing member is fixed to the top flange of the second reinforcing member; and
the connecting projection of the first reinforcing member is fixed to the second top wall of the second reinforcing member.

6. The rear side structure according to claim 5, wherein the connecting projection of the first reinforcing member is fixed to a rear portion of the second reinforcing member and a front portion of the third reinforcing member.

7. The rear side structure according to claim 6, wherein the third reinforcing member comprises a third top wall extending from the second reinforcing member toward the rear wheel house in the longitudinal direction of the vehicle.

8. The rear side structure according to claim 7, wherein:
the third reinforcing member further comprises an upper extension portion extending upward from a rear portion of the third top wall; and
the upper extension portion of the third reinforcing member is fixed to the rear wheel house.

9. The rear side structure according to claim 1, wherein:
a front portion of the third reinforcing member is overlapped with and fixed to a rear portion of the second reinforcing member; and
a rear portion of the third reinforcing member is fixed to the rear wheel house.

10. A rear side structure for a vehicle, the rear side structure comprising:
a side sill extending in a longitudinal direction of the vehicle;
a rear wheel house located behind the side sill;
a first reinforcing member fixed to a front portion of the rear wheel house;
a second reinforcing member fixed to a rear portion of the side sill; and
a third reinforcing member connecting the first reinforcing member and the second reinforcing member and fixed to the rear wheel house, the third reinforcing member comprising a top wall extending from the second reinforcing member toward the rear wheel house in the longitudinal direction of the vehicle.

11. The rear side structure according to claim 10, wherein:
the third reinforcing member further comprises an upper extension portion extending upward from a rear portion of the top wall; and
the upper extension portion of the third reinforcing member is fixed to the rear wheel house.

12. The rear side structure according to claim 10, wherein the first reinforcing member comprises:
a second top wall extending obliquely along the front portion of the rear wheel house;
a side flange extending along an inner edge of the second top wall;
a bottom flange extending from a bottom end of the side flange toward the second reinforcing member; and
a connecting projection protruding from a bottom end of the second top wall toward the second reinforcing member.

13. The rear side structure according to claim 10, wherein the second reinforcing member comprises:
a second top wall; and
a top flange connected to an inner edge of the second top wall.

14. A vehicle body comprising:
a roof side rail extending in a longitudinal direction of the vehicle body along a top of the vehicle body;
a side sill extending in the longitudinal direction of the vehicle body along a bottom of the vehicle body;
a front pillar disposed at a front of the vehicle body and connecting a front portion of the roof side rail and a front portion of the side sill;
a center pillar located behind the front pillar at a middle region of the vehicle body and connecting a middle portion of the roof side rail and a middle portion of the side sill;
a rear pillar located behind the center pillar at a rear of the vehicle body and connecting a rear portion of the roof side rail and a rear portion of the side sill;
a rear wheel house located behind the side sill and connected to the rear portion of the side sill by a plurality of reinforcing members, the reinforcing members comprising:
a first reinforcing member fixed to a front portion of the rear wheel house;
a second reinforcing member fixed to the rear portion of the side sill; and
a third reinforcing member connecting the first reinforcing member and the second reinforcing member and fixed to the rear wheel house.

15. The vehicle body according to claim 14, wherein the first reinforcing member comprises:
a first top wall extending obliquely along the front portion of the rear wheel house;
a side flange extending along an inner edge of the first top wall;
a bottom flange extending from a bottom end of the side flange toward the second reinforcing member; and
a connecting projection protruding from a bottom end of the first top wall toward the second reinforcing member.

16. The vehicle body according to claim 15, wherein the second reinforcing member comprises:
a second top wall; and
a top flange connected to an inner edge of the second top wall.

17. The vehicle body according to claim 16, wherein:
the bottom flange of the first reinforcing member is fixed to the top flange of the second reinforcing member; and
the connecting projection of the first reinforcing member is fixed to the second top wall of the second reinforcing member and is fixed to a rear portion of the second reinforcing member and a front portion of the third reinforcing member.

18. The vehicle body according to claim 17, wherein the third reinforcing member comprises a third top wall extending from the second reinforcing member toward the rear wheel house in the longitudinal direction of the vehicle body.

19. The vehicle body according to claim 18, wherein:
the third reinforcing member further comprises an upper extension portion extending upward from a rear portion of the third top wall; and
the upper extension portion of the third reinforcing member is fixed to the rear wheel house.

20. The vehicle body according to claim 14, wherein:
a front portion of the third reinforcing member is overlapped with and fixed to a rear portion of the second reinforcing member; and
a rear portion of the third reinforcing member is fixed to the rear wheel house.
